(19) United States
(12) Patent Application Publication
(10) Pub. No.: US 2009/0200313 A1
(43) Pub. Date: Aug. 13, 2009

(54) Microwave oven rupture-resistant food container

(76) Inventor: Jacob Deutsch, Brooklyn, NY (US)

Correspondence Address: MYRON AMER P.C., Suite 2B, 350 National Boulevard, Long Beach, NY, 11561-3327, US

(21) Appl. No.: 12/069,403

(22) Filed: Feb. 11, 2008

(51) Int. Cl. A47J 27/00; H05B 6/80; B65D 8/04

(52) U.S. Cl. 220/573.1; 219/725; 220/669

(57) ABSTRACT

A food container for preparing food in a microwave oven of plastic construction material that resists rupturing by its shape modification that is subjected to forces generated by the microwaving process.

The present invention relates generally to improvements in microwave oven food containers and, more particularly, to obviating the rupturing of the plastic construction material of these containers due to water vapor content removal during the operating mode of the microwave oven, all as will be better understood as the description proceeds.

### BACKGROUND OF THE INVENTION

### 1. Field of Search

Microwave ovens are quick and convenient for cooking or heating foods. This has led to the creation and rapid growth of “convenience foods,” i.e. readily-prepared foods which have been cooked or partially cooked and only require reheating in a microwave oven.

Improvements have focused on the use of a microwave oven container of a food grade of polypropylene, a preferred material being that manufactured under the trademark NOVOLEN 1102 (BASF) as but one of several available commercially-available sources.

While appropriately chemically constituted, the microwave oven food container has been found in practice not to be structurally constituted to withstand rupture due to the pressures exerted thereon by the operating mode of the microwave oven.

### SUMMARY OF THE PRESENT INVENTION

Broadly, it is an object of the present invention to overcome the foregoing and other shortcomings of the prior art.

More particularly, it is an object to allow for movement of the food-container structural panels subject to microwave oven generated pressures, such movement in practice resulting in obviating what otherwise would be rupturing consequences.

### BRIEF DESCRIPTION OF THE SEVERAL VIEWS OF THE DRAWINGS

The description of the invention which follows, together with the accompanying drawings should not be construed as limiting the invention to the example shown and described, because those skilled in the art to which this invention appertains will be able to devise other forms thereof within the ambit of the appended claims.

FIG. 1 is a perspective view of Rupture-Resistant Food Container constructed and having an operating mode according to the present invention;

FIG. 2 is a partial perspective view as taken along line 2-2 of FIG. 1;

FIG. 3 is a partial perspective view of the structure circumscribed by the arrow 3 of FIG. 1;

FIG. 4 is a partial perspective view similar to FIG. 2 and illustrating an initial parameter of the operating mode of the Rupture-Resistant Food Container; and

FIG. 5 is a partial perspective view similar to FIG. 4 and illustrating further details of a subsequent parameter of the operating mode of the Rupture-Resistant Food Container.

### DETAILED DESCRIPTION OF THE PREFERRED EMBODIMENT

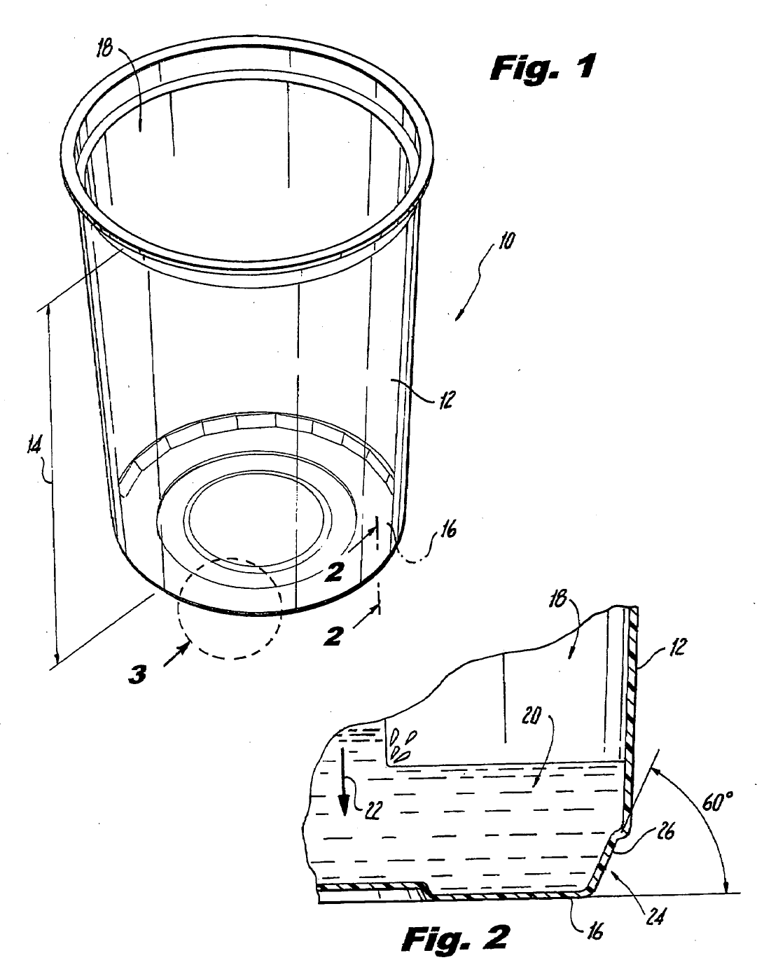

Illustrated in FIG. 1 is an injection molded article of manufacture, generally designated 10, of polypropylene or like plastic construction material having a cylindrical body panel 12, only one of which is shown, but could be supplemented in graduated three sizes, the largest being that illustrated and being of a height 14 of approximately five-and-a-half (5½) inches, the middle size of a height of three (3) inches, and the smallest of a height of approximately two (2) inches.

The manufactured article 10 has the noted body panel 12 in a cylindrical configuration which extends vertically from a circular bottom panel 16 and which panels 12, 16 bound a food-containing cooking compartment 18.

As shown in FIG. 2, a typical selected food, designated 20, of the previously-noted “convenience food” category, having a water vapor content and a fluid viscosity, is placed in the compartment 18 and undergoes a downward gravity flow movement, as noted by arrow 22, into a position on top of the bottom panel 16 and laterally outwardly to the intersection site 24 of the panels 12, 16.

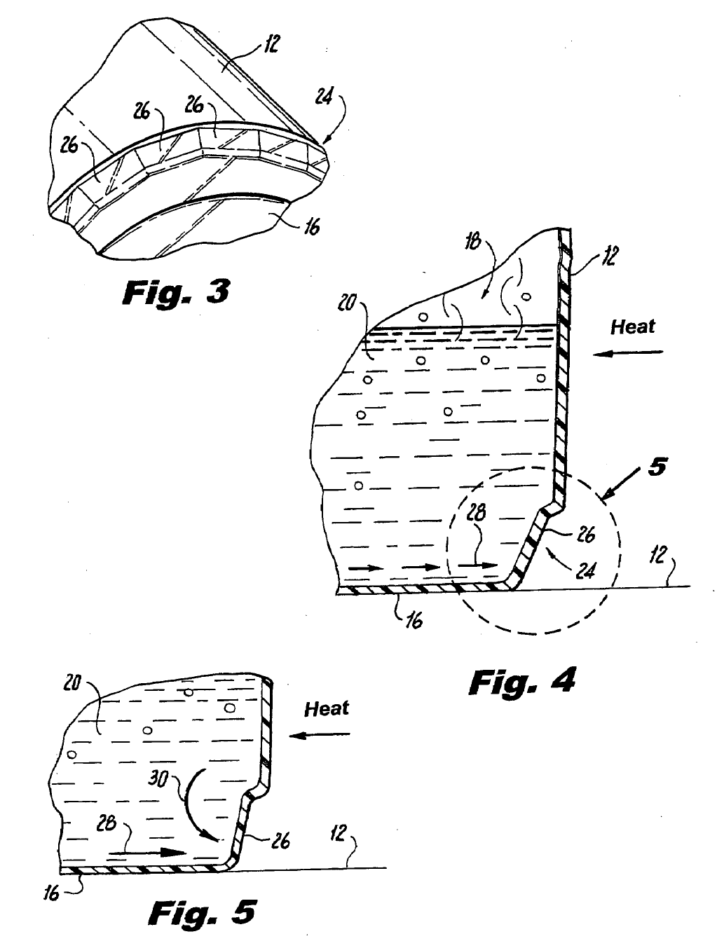

As best seen in FIG. 3, at the site 24, there is provided an array, generally collectively and individually designated 26 of angularly oriented food-encircling operative panels, subtending an acute angle of preferable sixty (60) degrees located in the path 22 of the food gravity flow.

During the operating mode of the microwave oven 10, as shown in FIG. 4, there is microwave oven generated movement, as noted by arrow 28, of food contents 20 against the angularly oriented panels 26 due to microwave oven removal of the water vapor content of the food 20 and the resulting water pressure pushing the food 20 laterally along the bottom panel 16. The water pressure causes a counterclockwise pivotal traverse 30 of the panels 26, as best seen in the enlarged, fragmentary view of FIG. 5, obviating rupturing of the article 10 at the intersection site 24 which, in practice, would otherwise occur without the noted pivotal traverse 30.

While the method disclosed in detail is fully capable of attaining the objects and providing the advantages hereinbefore stated, it is to be understood that it is merely illustrative of the presently preferred embodiment of the invention and that no limitations are intended other than as defined in the appended claims.

What is claimed is:

1. A container article of manufacture of microwave oven plastic construction material comprising:
A. a body panel in a cylindrical configuration in a vertical upstanding orientation from a circular bottom panel cooperating to bound a food-containing cooking compartment;
B. a selected food constituted of a water vapor content having an operative position in said food-containing cooking compartment and undergoing a downward position of movement due to gravity flow into a superposed position upon said bottom panel;
C. an array at an intersection of said body panel with said bottom panel of plural angularly oriented food-encircling operative panels subtending an acute angle located in said path of said food gravity flow;
D. microwave-urged movement into lateral positions of movement of said food contents into contact against said acute angle subtended operative panels; and
E. operative movement of a rotatable pivotal traverse in said operative panels to obviate rupture in said plastic construction material at said intersection of said body panel with said bottom panel due to microwave oven removal of said water vapor content of said food and corresponding lateral expansion of said food in said superposed position upon said bottom panel;
whereby said container article of manufacture is rendered rupture resistant in its microwave oven operating mode.
